(19) United States
(12) Patent Application Publication
(10) Pub. No.: US 2014/0130684 A1
(43) Pub. Date: May 15, 2014

(54) OVEN WITH VARIOUS FEATURES, INCLUDING BOOST HEATING AND PREHEAT STATUS

(71) Applicant: Duke Manufacturing Co., St. Louis, MO (US)

(72) Inventors: Robert J. Reese, Edwardsville, IL (US); Steven M. Shei, Fort Wayne, IN (US)

(73) Assignee: Duke Manufacturing Co., St. Louis, MO (US)

(21) Appl. No.: 14/072,472

(22) Filed: Nov. 5, 2013

Related U.S. Application Data
(60) Provisional application No. 61/760,514, filed on Feb. 4, 2013.
(60) Provisional application No. 61/722,607, filed on Nov. 5, 2012.

(51) Int. Cl. A47J 36/24; H05B 1/02

(52) U.S. Cl. CPC A47J 36/2488; H05B 1/0263
USPC 99/483; 219/412

(57) ABSTRACT

A heat control for an oven permits selective overriding of a holding cycle heating recipe with a boost heating recipe to deliver a boost of heat to food held in a heating compartment. Various types of boost heating recipes may be used. A heat control for an oven graphically displays stages of completion of a preheat cycle on an operator interface. Associated ovens and methods are also disclosed.

### FIELD OF THE INVENTION

The present invention generally relates to food service equipment, and more particularly to a product holding unit (“PHU”) for holding pre-cooked food before it is served.

### BACKGROUND OF THE INVENTION

PHU configurations and controls have been growing in sophistication. However, improvements are needed.

### SUMMARY

The present invention is directed to improved controls for a PHU or similar device and improved infrared emitter features for such a device.

Other objects and features will be in part apparent and in part pointed out hereinafter.

### BRIEF DESCRIPTION OF THE DRAWINGS

FIGS. 1-14 are illustrations of various features of this invention for a PHU.

Corresponding reference characters indicate corresponding parts throughout the drawings.

### DETAILED DESCRIPTION

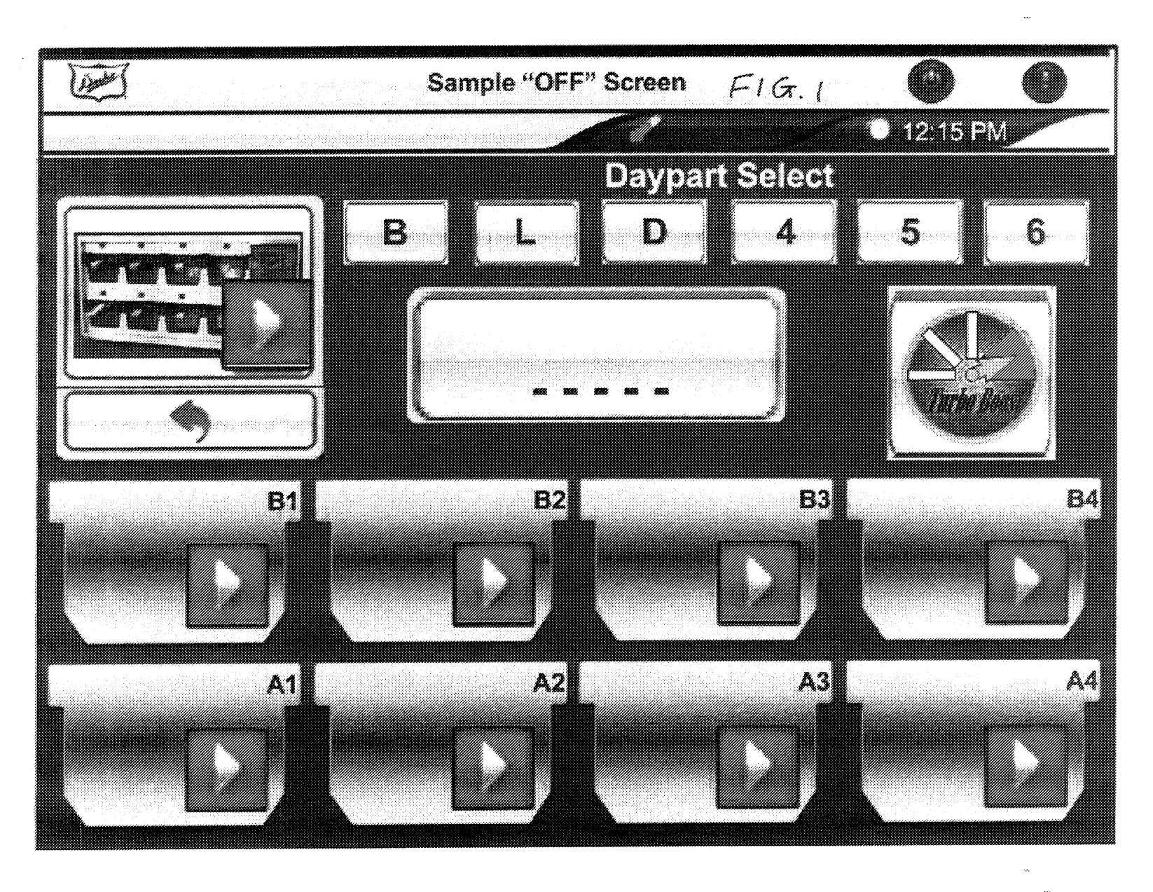

Referring to the drawings, FIG. 1 illustrates a control 10 for a PHU having a 4×2 array of heating compartments. Each heating compartment has at least one heat source for heating food in the compartment, and a control 10 for controlling operation of the heat sources to deliver heat to food in respective heating compartments. The control 10 includes a processor (e.g., a microprocessor), instructions (e.g., software) used by the processor for varying the heat delivered by the heat sources according to predetermined heating recipes suitable for holding different foods in respective heating compartments, and a timer associated with the processor for timing the hold time of food products in the heating compartments. Typical food includes hamburgers, fish, fries, rolls, biscuits, nuggets, etc. The heating recipes programmed into the control will vary depending on the type of food to be heated and other factors.

In one embodiment, the heat source for each heating compartment includes a heat sink of the type described in co-assigned U.S. Pat. No. 6,175,099 and/or an overhead heater of the type described in co-assigned U.S. Pat. Nos. 7,227,102 and 7,105,779, all of which patents are incorporated herein by reference. Other heat sources may be used.

Still referring to FIG. 1, the control 10 includes an operator interface 20 having a depiction of the PHU 22 and its array of heating compartments, and a corresponding array of compartment displays (e.g., compartment outlines) A1-A4, B1-B4 associated with respective heating compartments of the PHU. Each compartment display A1-A4, B1-B4 displays relevant information about a respective heating compartment, such as the food product to be placed in the compartment, the heated state of the compartment, and the remaining hold time of the food in the compartment. The control 10 also includes a series of start actuators 30 (e.g., green-arrow buttons) associated with respective compartment displays A1-A4, B1-B4 for initiating heat-up and hold procedures for respective heating compartments, a series of “Daypart Select” actuators B, L, D, 4, 5, and 6, a “Turbo Boost” actuator 32, and a “Cook Next” display 34. The function of these displays and actuators will be described hereinafter.

Prior to start-up of the PHU, the operator interface 20 appears as shown in FIG. 1. The compartment displays A1-A4, B1-B4 display a color (e.g., gray) indicating the compartments are not heated.

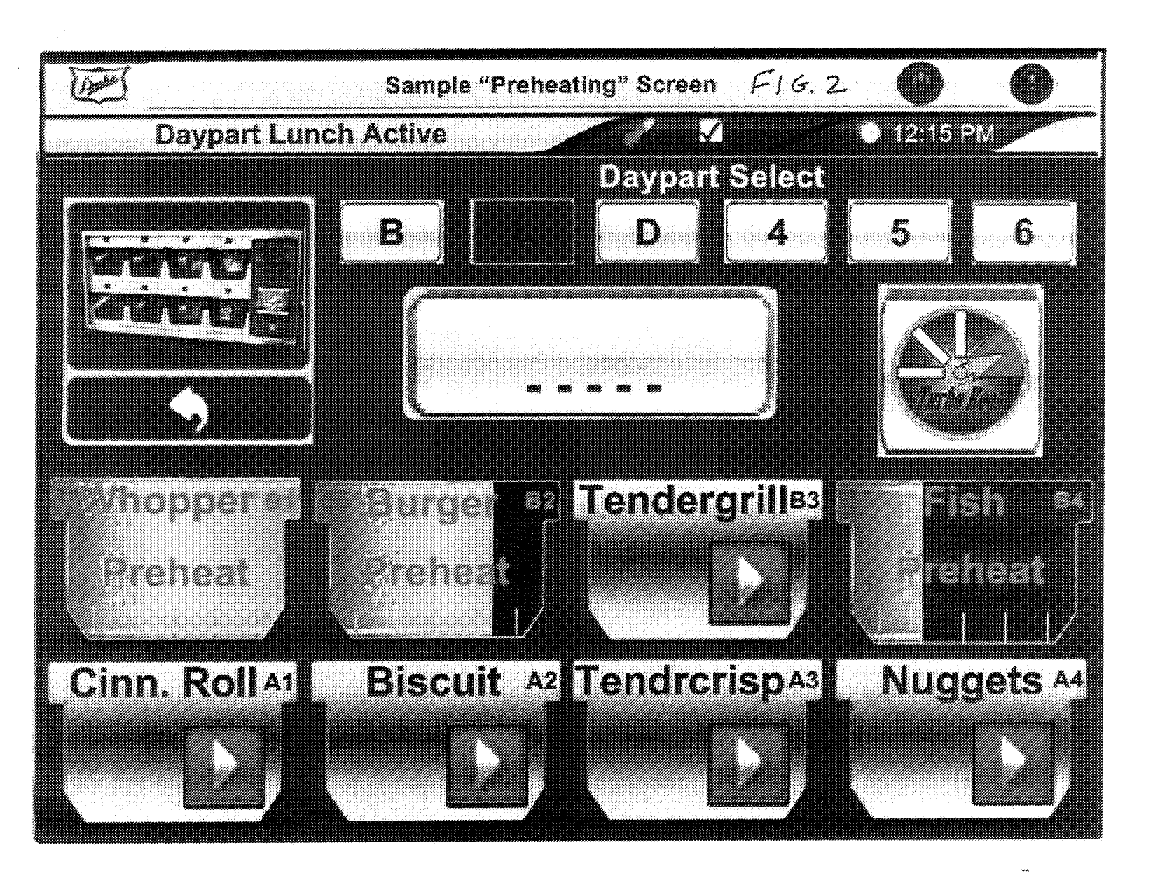

In FIG. 2, Daypart Select actuator L is activated, indicating that the PHU is to be controlled using instructions suitable for holding a lunch menu of food. In response, food-indicators are displayed in or close by respective compartment displays A1-A4, B1-B4 to indicate the various food products to be placed and held in respective heating compartments. Alternatively, Daypart Select actuator B may be actuated, indicating that the PHU is to be controlled using instructions suitable for holding a breakfast menu of food. In response, food-indicators are displayed in or close by respective compartment displays A1-A4, B1-B4 to indicate the various breakfast food products to be placed and held in respective heating compartments. Similarly, Daypart Select actuator D may be actuated, indicating that the PHU is to be controlled using instructions suitable for holding a dinner menu of food. In response, food-indicators are displayed in or close by respective compartment displays A1-A4, B1-B4 to indicate the various dinner food products to be placed and held in respective heating compartments. In a similar manner, other pre-programmed menus may be selected by actuating Daypart Selectors 4, 5, and 6.

To initiate a pre-heat process for a heating compartment, the start actuator 30 for that compartment is activated to energize one or more heat sources in the selected heating compartment to pre-heat the compartment to a temperature(s) suitable for the food product to be placed in the compartment. Preheat information relevant to the status of the preheat cycle is displayed by suitable means, such as a by a changing color line progressing across the compartment display A1-A4, B1-B4, or by a readout of preheat completion percentage in the compartment display, or by a readout which shows the actual temperature. In FIG. 2, for example, the preheat condition is displayed as being complete for compartment B1 and in varying stages of completion for compartments B2 and B4.

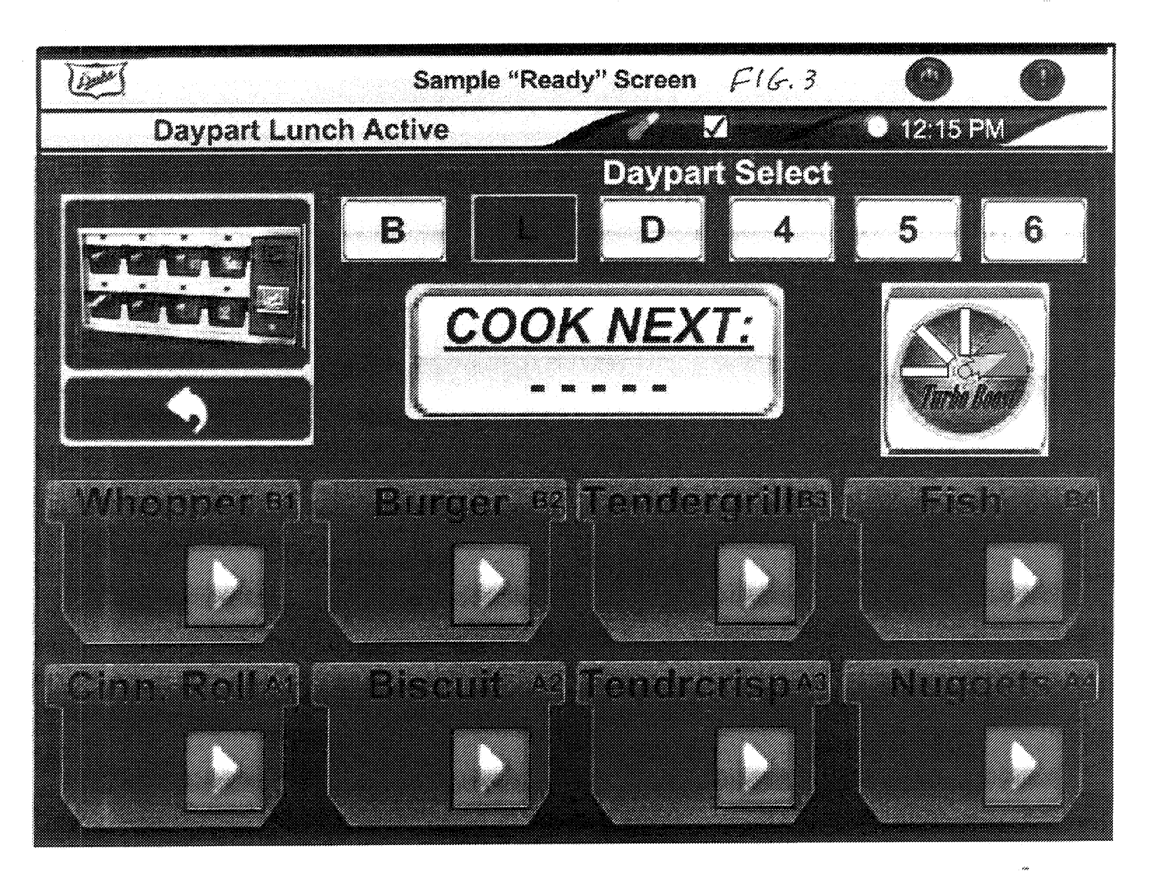

In FIG. 3, all heating compartments are displayed as being fully pre-heated and “ready” for holding food product. This display may appear as a change in the color (e.g., to blue) in each heating compartment display A1-A4, B1-B4. Other “ready” colors or indications may be used.

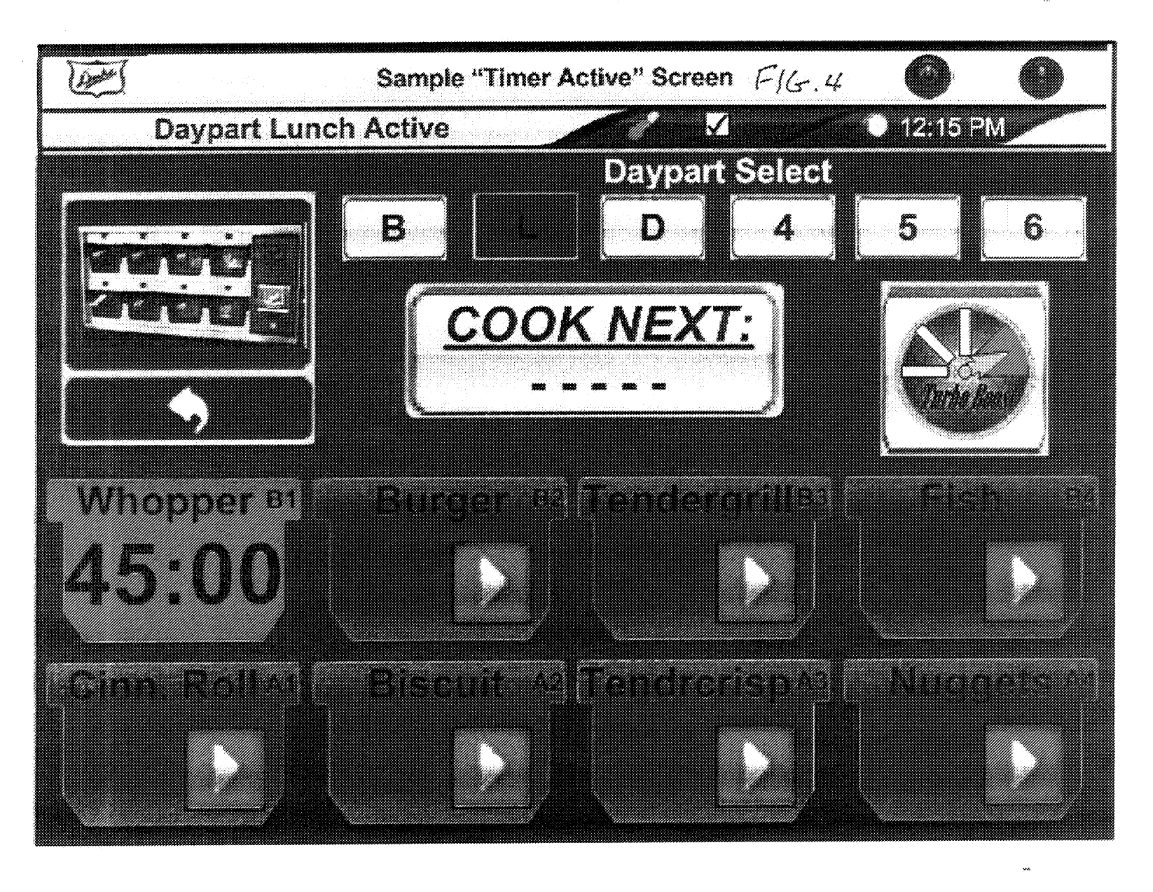

In FIG. 4, the start actuator 30 for compartment B1 is pressed to activate the timer for counting down the maximum hold time for the particular food product placed in the heating compartment when the food product has completed its cooking cycle or a tray of food product is placed in such heating compartment. The remaining hold time is displayed in or close by the compartment display B1.

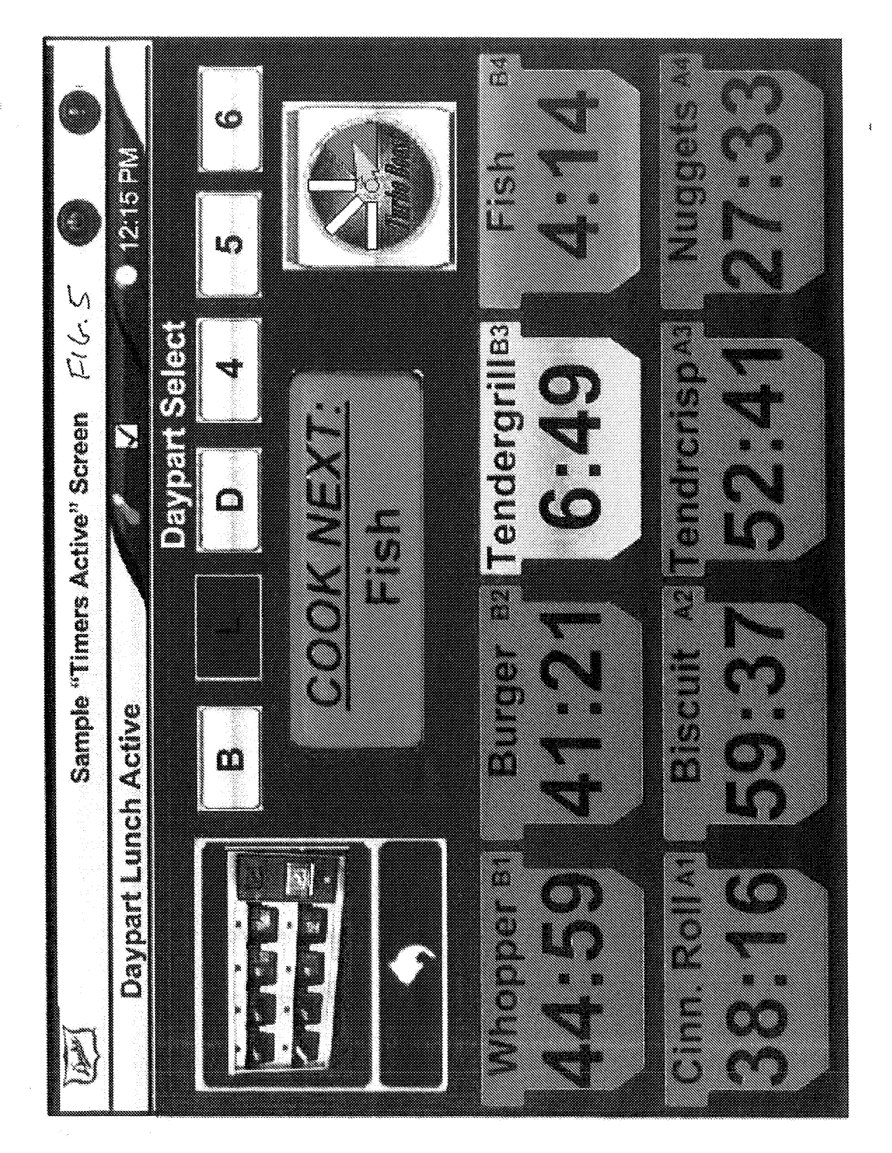

In FIG. 5, the general status of the remaining hold time for the food in different heating compartments is indicated by different colors in the compartment displays A1-A4, B1-B4. By way example, the color green indicates that a compartment has substantial hold time remaining (e.g., more than 10 minutes), and the color yellow indicates that a compartment (compartment B3) has a relatively small amount of hold time remaining (e.g., less than 10 minutes).

Also, in FIG. 5, the “Cook Next” display 34 displays “Cook Next Fish”, meaning that the cook time for fish, i.e., the time it takes to cook a batch of fish, is greater than the remaining hold time for the fish held in compartment B4, which is the only compartment holding fish in this example. The “Cook Next” signal alerts the operator that a batch of fish should be cooked as soon as possible to minimize the risk of running out of fish food product that may be ordered by a customer. Optionally, the compartment representation for compartment B4 holding the fish also changes color to match the color of the “Cook Next” display, thereby informing the operator of the remaining hold time for the fish food product in that compartment. The “Cook Next” display 34 is applicable to any food product held in the PHU, and it may flash intermittently between various food products and heating compartments where the hold times remaining for multiple compartments have fallen below the cook times for the products in respective compartments, as necessary or desirable.

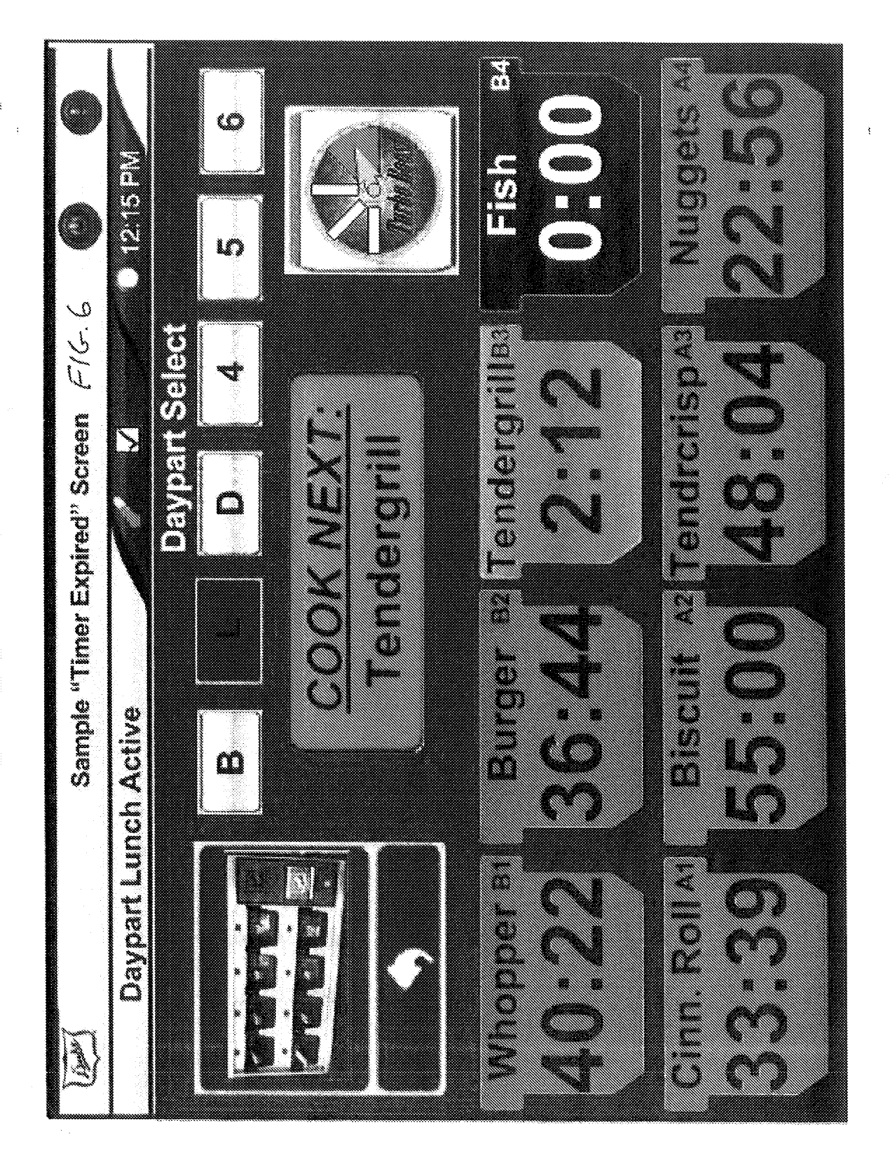

FIG. 6 is similar to FIG. 5, except that the hold time for the fish food product in compartment B4 has timed out, indicating that the hold time has expired and that the food should disposed of without serving it. The expiration of the hold time is displayed by a timer count of 00.00 and by a display of an appropriate color (e.g., black) in compartment display B4. Also in FIG. 6, the “Cook Next” display 34 displays “Cook Next Tendergrill”, indicating that the cook time for the Tendergrill food product in compartment B3 is greater than the remaining hold time for that compartment, which is the only compartment containing this particular food product.

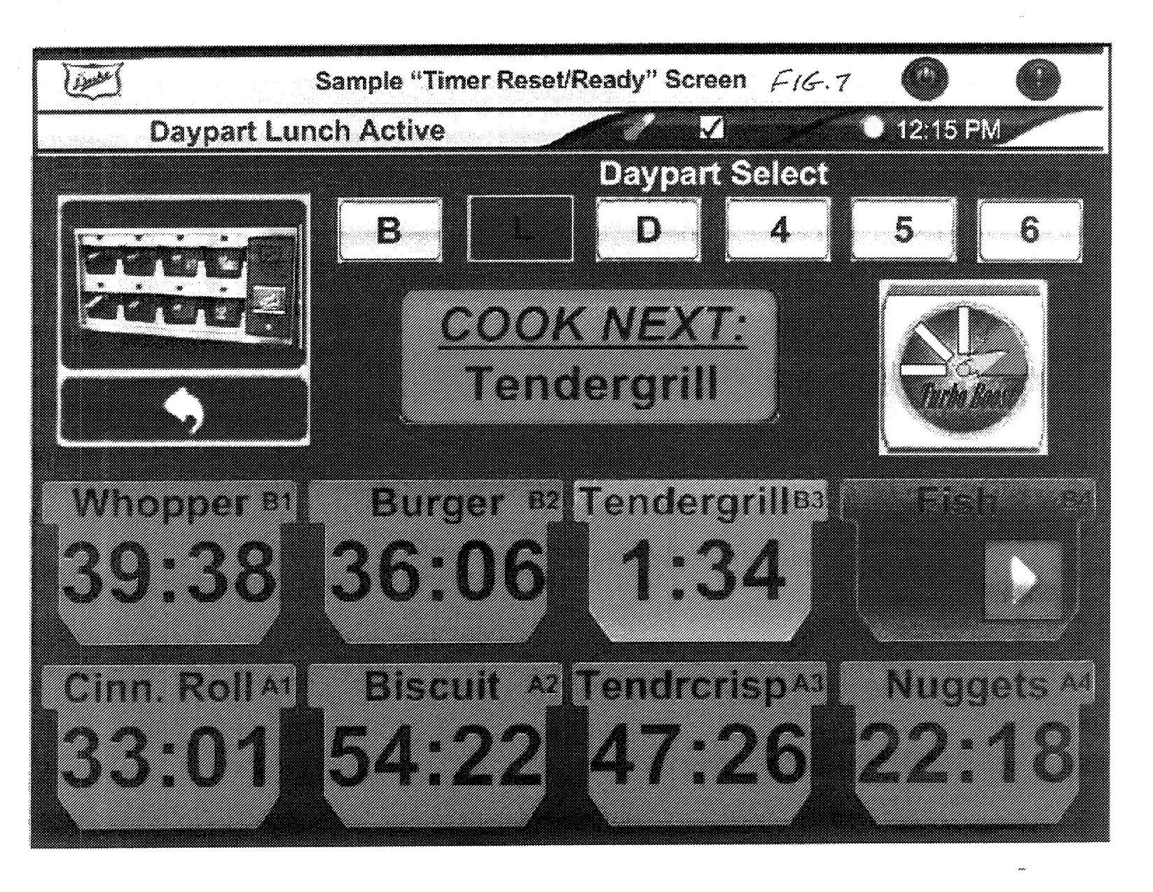

FIG. 7 is similar to FIG. 6 except that the compartment B4 displays a color (e.g., blue) indicating that it is heated and ready for receiving another batch of food product. The timer for this compartment is reset to time out a new holding time upon activation of the start actuator 30.

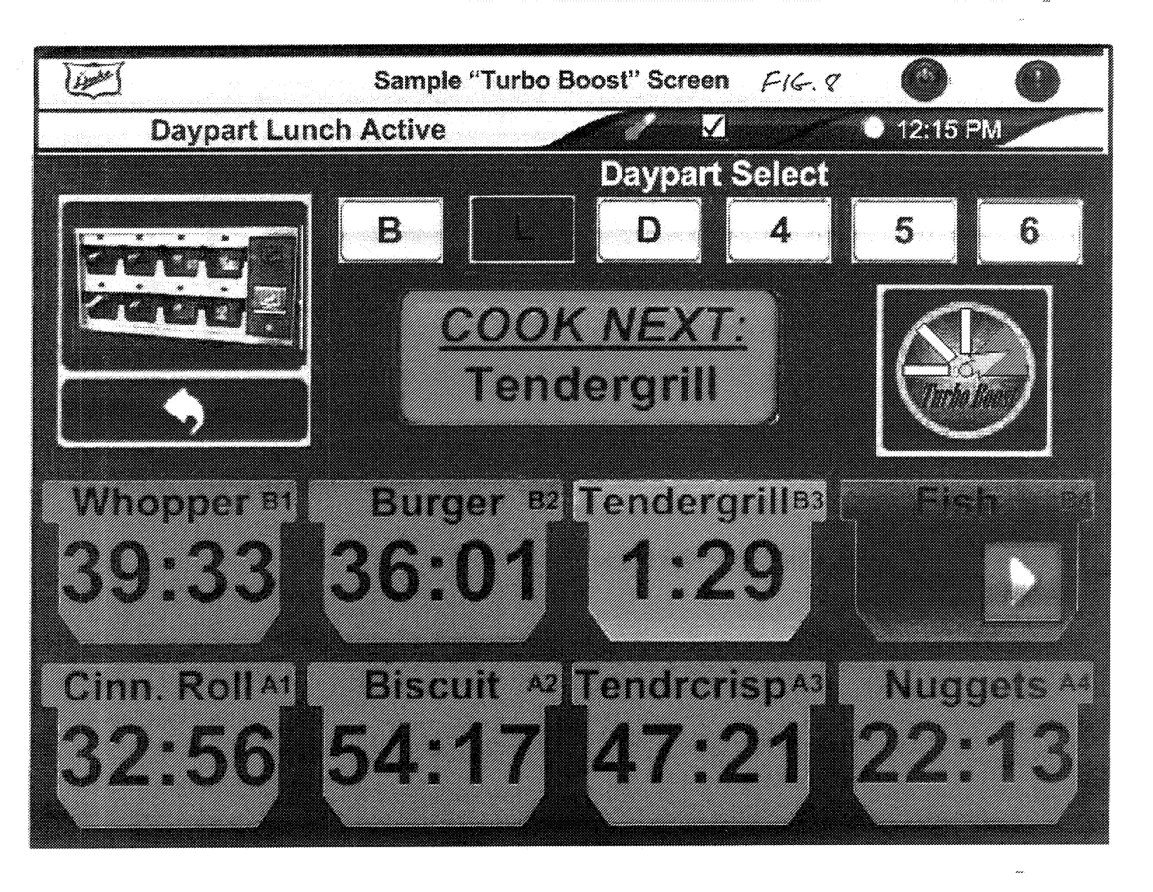

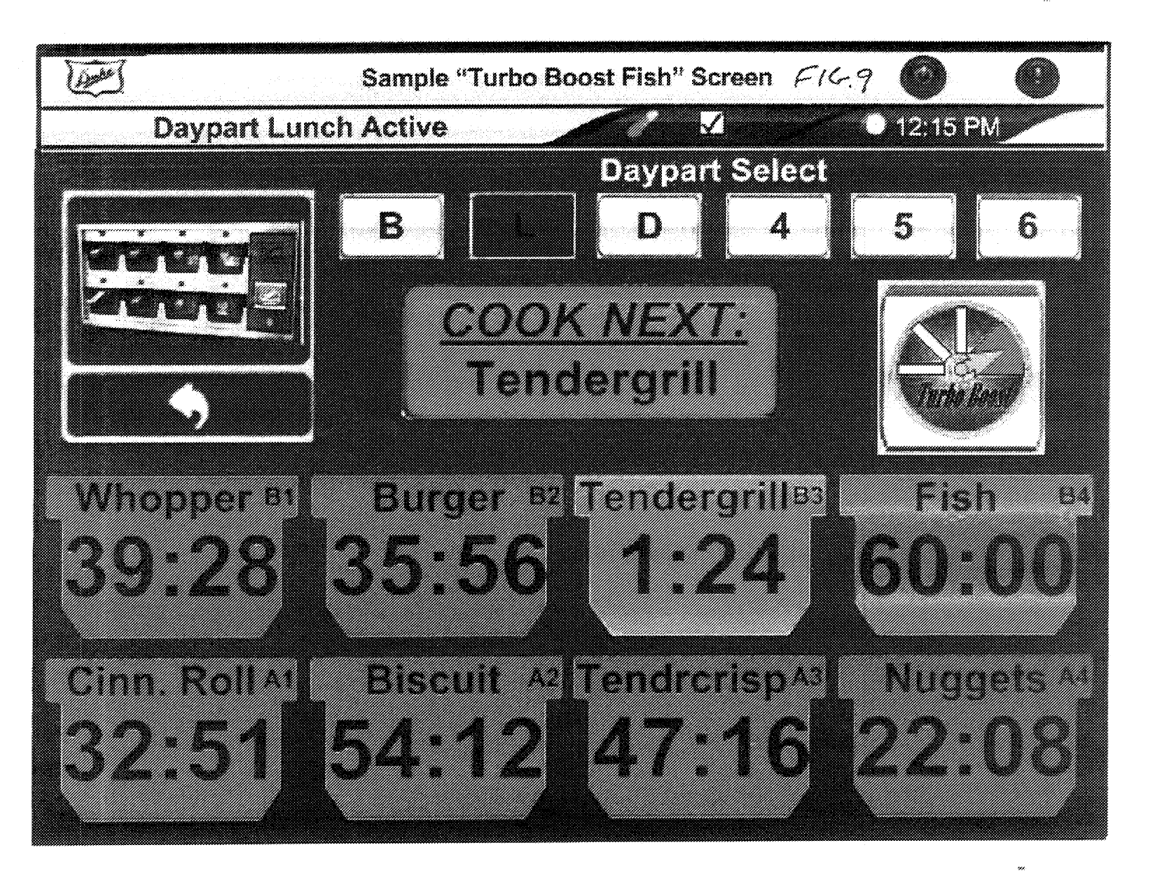

FIGS. 8-11 are similar to FIG. 7 except that they demonstrate the operation of the “Turbo Boost” actuator 32, which may be a switch that is operable by an operator of the PHU to modify the heating recipe for a particular heating compartment. In FIG. 8, the operator has pressed the “Turbo Boost” actuator 32, indicating that a heating recipe is to be modified. In FIG. 9, the operator has placed a tray of food (fish in this case) in compartment B4 and pressed the start actuator 30 for this compartment, thus selecting heating compartment B4 as the compartment for which the heating recipe is to be modified. In response to actuation of “Turbo Boost” actuator 32 and the start actuator 30 for heating compartment B4, the processor and associated software operate to modify the usual heating recipe for the food in compartment B4. (The “usual” heating recipe is determined by programmed instructions.) By way of example, the usual heating recipe can be modified to energize the heating source(s) in compartment B4 to deliver an increased amount of heat to the food to bring it up to a desired holding temperature more quickly than usual. Thus, the “Turbo Boost” actuator 32 can be used by an operator as a device for more quickly heating the food product in a selected compartment. For example, the operator may know the food inserted into the PHU was left unheated for a duration of time before being inserted into the PHU. The operator can selectively actuate the “Turbo Boost” actuator 32 to rapidly bring the temperature of the food up to the desired holding temperature (e.g., as if the food were more recently removed from a cooking device such as a grill or fryer). The degree of “boost” can vary according to food product and other factors and is determined by programmed instructions provided to the processor controlling the operation of the heating sources in the heating compartments. The “boost recipe” can be time-based (open loop) or temperature-based (closed loop).

The turbo boost feature may be used in other ways than boosting the temperature of food at the beginning of a food holding period. For example, the “Turbo Boost” actuator 32 may be used to alter or override a pre-programmed holding cycle at any time during the holding cycle (including various times between the beginning and the end of the holding cycle, or at or near the end of the holding cycle). At any time of a holding cycle of a heating compartment, the “Turbo Boost” actuator 32 may be actuated, and the desired heating compartment display A1-A4, B1-B4 may then be actuated to execute a turbo boost recipe for that compartment. For example, referring to FIG. 8, in which the Turbo boost button is shown as actuated, the Tendergrill heating compartment display B3 may then be actuated to cause the control to execute the turbo boost in that compartment. The turbo boost executed may be a generic turbo boost used for several of the food types, or the turbo boost (heat/time) may be specific to the particular food being held in the compartment. For example, the control 10 may know tendergrill is being held in the compartment (as indicated by the “Tendergrill” icon on the compartment display), and the control may execute instructions stored to perform a particular turbo boost cycle (heat/time) specifically intended for tendergrill.

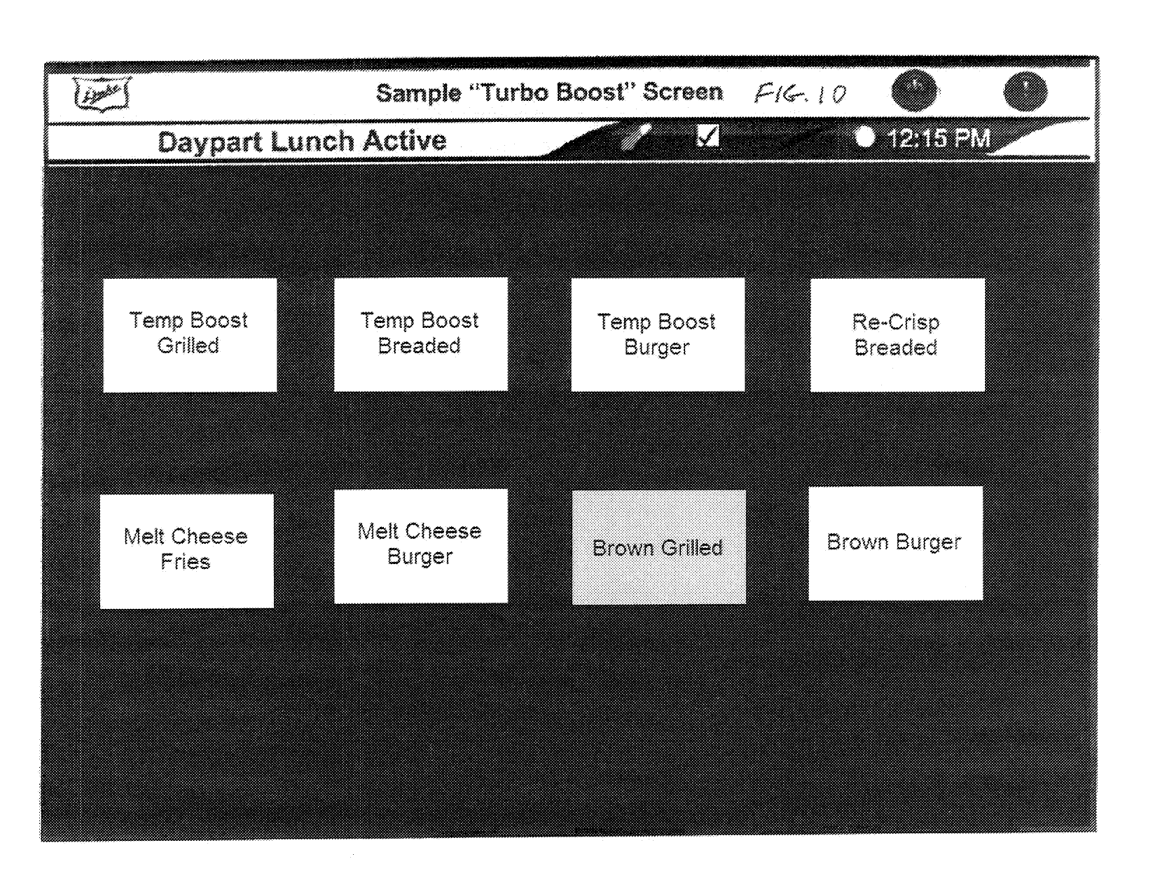

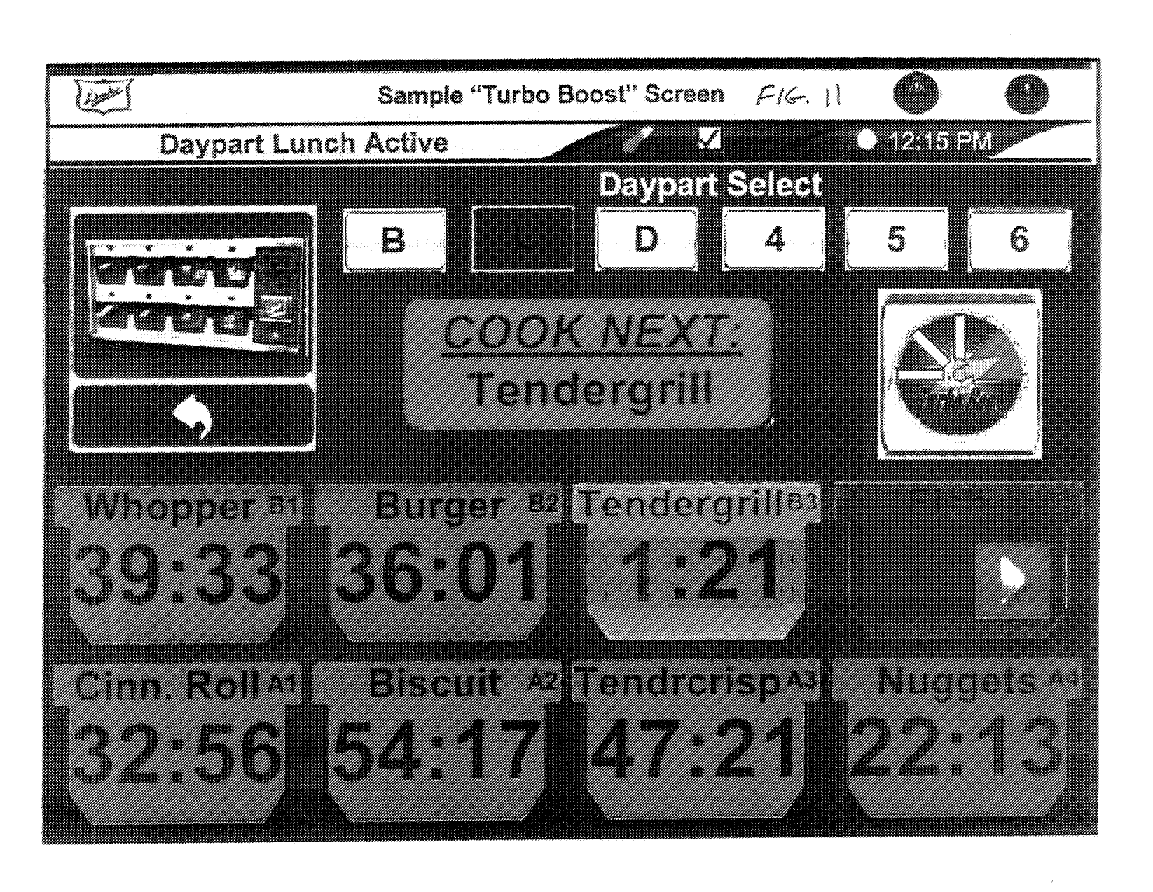

FIG. 10 illustrates a menu which may be displayed after activation of the “Turbo Boost” actuator 32. The menu may provide several options T1-T8 for various types of turbo boost, a few of which are illustrated by example without limitation. For instance, at the beginning of a holding cycle, it may be desirable to boost the temperature of grilled, breaded, or burger food products according to different recipes. Three buttons T1-T3 are provided for these separate scenarios. After, pressing the desired button (e.g., “Temp Boost Grilled” T1), the display may return to the previous view in which the fish holding compartment display B4 may be selected to achieve temperature boost of grilled fish (e.g., as indicated in FIG. 9). In other examples, it may be desirable to use turbo boost in other ways, such as to re-crisp breaded (fried) food, to melt cheese on fries, to melt cheese on burger patties, to brown grilled food products, and/or to brown burger patties. Corresponding T4-T8 buttons are provided for each of these tasks in the turbo boost menu shown in FIG. 10. It will be understood other functions or operations may be used without departing from the scope of the present invention. Actuation of one of these buttons T1-T8 (e.g., “Brown Grilled” T7 as shown in FIG. 10 by the orange color), returns the view to the prior screen, such as shown in FIG. 11, in which the Tendergrill compartment display B3 may be selected (shown as selected in FIG. 11) so that the control 10 executes a turbo boost recipe to brown the tendergrill near the end of its holding cycle (only 1:21 remaining). This type of turbo boost near or at the end of a holding cycle (or before it is otherwise anticipated to remove food from the heating compartment) may be desirable to heat the food to a higher temperature for serving or to add color to the food prior to serving. It will be understood that the other buttons, such as re-crisp breaded food T4, and melt cheese on fries T5 or burger patties T6 may be used in similar ways. The turbo boost could be used before it is anticipated to remove food from a respective heating compartment to increase heat delivered to breaded food to re-crisp it such as by drying potentially soggy breading or to increase heat delivered to food on which cheese has been positioned for melting it.

It will be appreciated that the turbo boost feature of the present invention may be executed in various ways (e.g., as disclosed above, or by other execution means such as designated “Turbo Boost” actuators for each individual heating compartment, or even by remote means such as a smart phone or tablet in operative communication with the PHU). In general, the turbo boost feature includes selective modification or overriding of a pre-programmed holding cycle at any time during the holding cycle to deliver a boost of heat. The boost of heat may be delivered in a recipe or cycle (heat/time) as determined for a particular food product or as a generic recipe or cycle used for several food products. For example, in a turbo boost recipe or cycle, it may be desirable to vary the amount of heat delivered, such as from a highest level, to an intermediate level, and then to a lower level. Other cycles may be used without departing from the scope of the present invention.

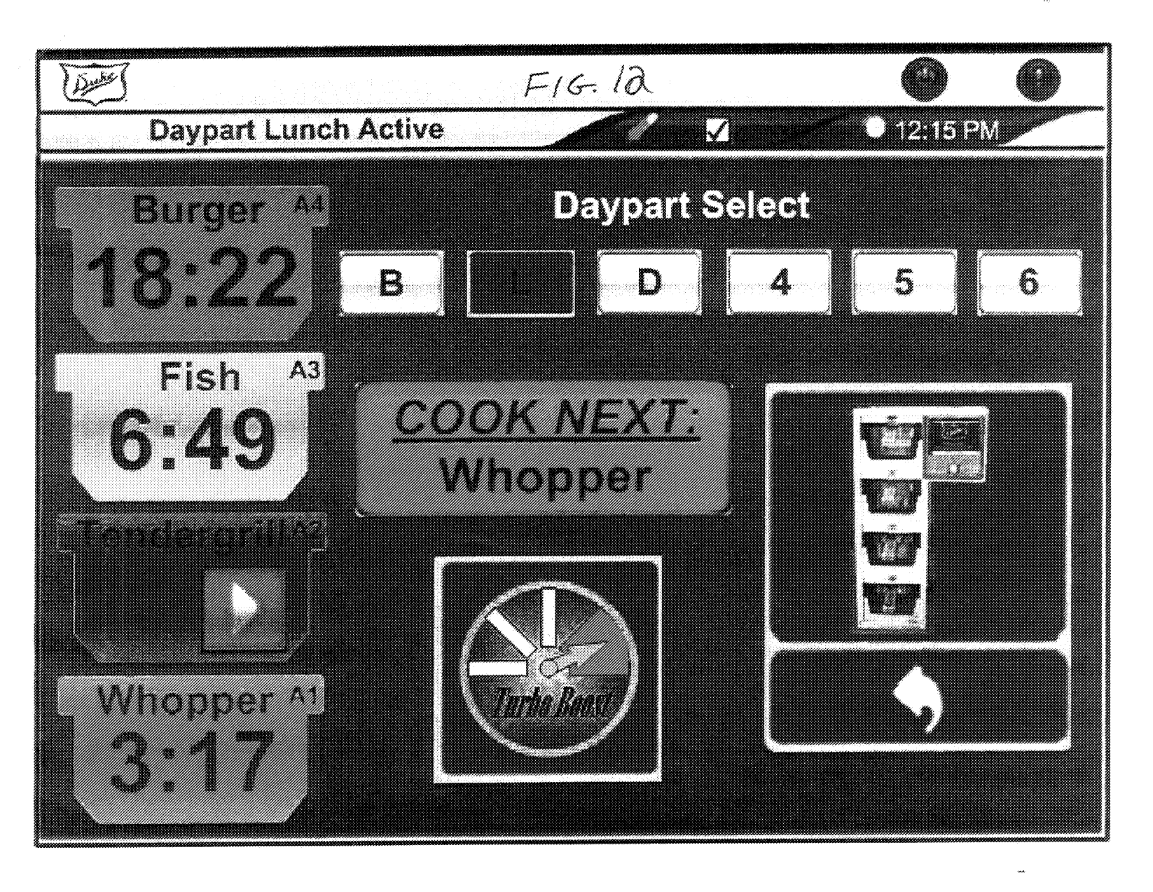

FIG. 12 illustrates a control 110 similar to the control 10 described above, except that the FIG. 10 control is for a PHU with a vertical array of heating compartments A1-A4.

A PHU of this invention may have a control with any selected combination of features described above. For example, the control may include any one or more of the preheat status, Cook Next, and/or Turbo Boost features.

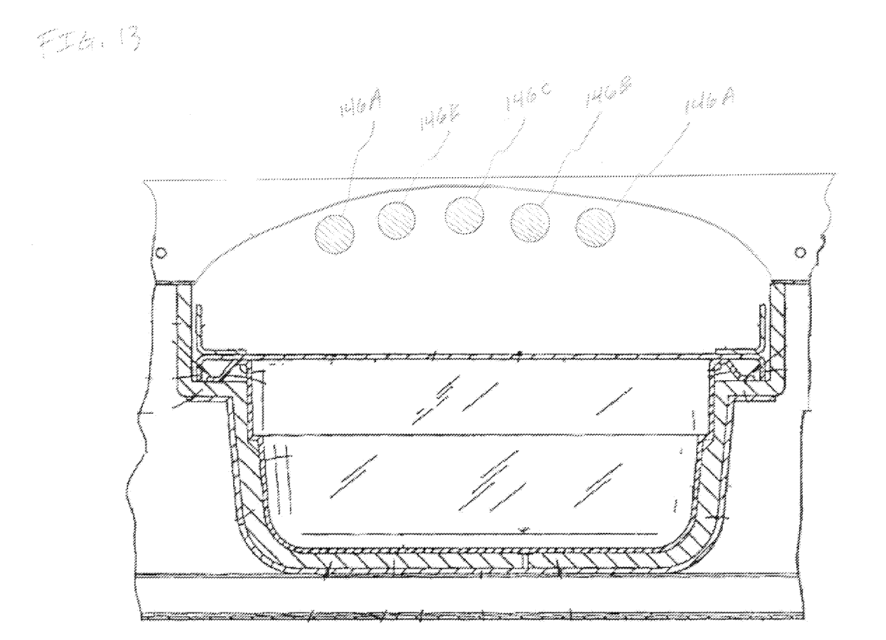

FIG. 13 illustrates an example heating compartment 260 of the present invention. The heating compartment 260 is similar to some of which are described in co-assigned U.S. Pat. Nos. 7,227,102 and 7,105,779, referred to above. For example, the heating compartment 260 includes a lower heat source in the form of a heat sink 264 for heating a bottom and/or sides of a pan 266 of food inserted in the heating compartment. The heating compartment 260 also includes an upper heat source. In this embodiment, the upper heat source includes a plurality of infrared emitters 276A-276C such as quartz, ceramic, or halogen infrared heat sources. The plurality of emitters 276A-276C may include emitters which are configured differently for emitting different levels of infrared heat. For example, at full duty cycle, a first emitter or emitters 276A may be configured for emitting a relatively highest amount of infrared heat, a second emitter or emitters 276B may be configured for emitting a relatively intermediate level of infrared heat, and a third emitter 276C (or emitters) may be configured for emitting a relatively lowest amount of infrared heat. The variation of the configurations of the emitters 276A-276C provides the controller with a spectrum of temperatures which it may deliver to the food held in the heating compartment 260. For example, some or all of the emitters 276A-276C may be energized at full duty cycle, partial duty cycle, or not energized. Further, the control may include instructions (software) for operating the first, second, and third emitters 276A-276C simultaneously according to a first heating recipe and for operating at least one of the first, second, and third emitters non-simultaneously with respect to the second and third emitters according to a second heating recipe. This flexibility provides the control with the ability to achieve a desired infrared heat delivery not only by changing duty cycle but also by energizing one or more emitters 276A-276C which are configured to emit different amounts of infrared heat at full duty cycle. It may be more efficient to operate the emitters 276A-276C at full duty cycle than at a partial duty cycle, in which case the relatively high, intermediate, and/or low level infrared heat emitters can be turned entirely on or off to accomplish a similar heating as one or more emitters operated according to a duty cycle. This type of plurality or group emitter configuration may be used for executing a turbo boost recipe or cycle, as described above, or for other heating needs. The number of emitters used as an upper heat source in any particular compartment may vary from two to three or more.

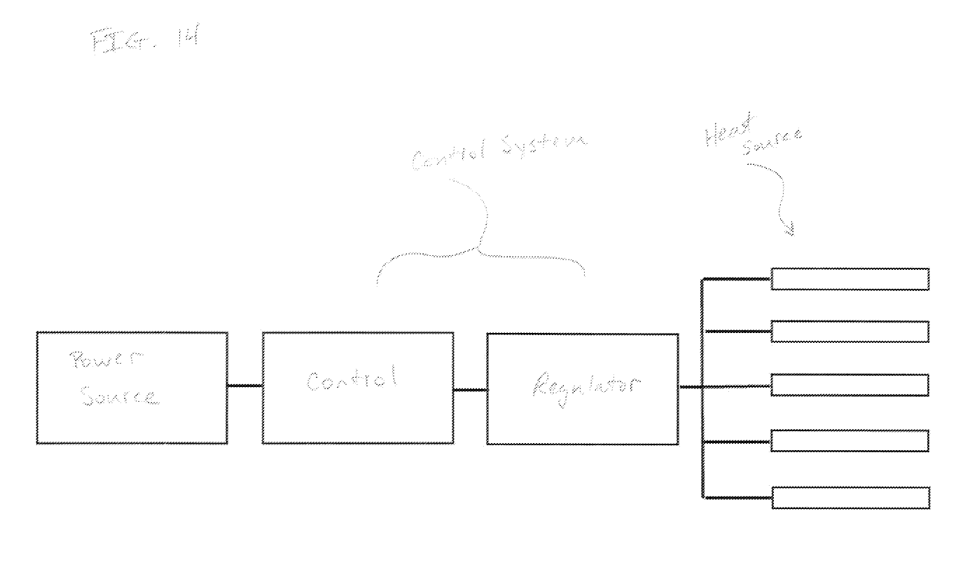

Heat emitted by a heat source may be controlled in other ways than, for example, changing duty cycle or turning on/off emitters configured for emitting different types of heat. Heat emission may be adjusted by controlling the energy supplied to the heat source. For example, a voltage adjustment device 370 may be used for controlling voltage delivered to an infrared heat source 372. Voltage adjustment devices 370 may have various forms, including but not limited to solid state voltage regulators, variable transformers, and/or resistors switchable in and out of a circuit. FIG. 14 illustrates an electrical schematic of a PHU in which the PHU has a control system 380 including a control 310 and a regulator 370 (e.g., a solid state voltage regulator). The control system 380 is adapted for operative connection to a power source 390 for energizing a heat source 372 and for controlling operation of the heat source, which in the illustrated embodiment is shown as a plurality of infrared heat emitters 372A-372E. The regulator 370 operates to regulate the voltage delivered to the infrared heat emitters 372A-372E to control the amount of infrared heat which they emit. This is in comparison to delivering a constant voltage to the infrared heat emitters 372A-372E at varying duty cycles. The regulator 370 provides the ability to control the voltage delivered to the infrared heat emitters 372A-372E, which in turn provides the ability to control the amount of infrared heat which the emitters emit.

Having described the invention in detail, it will be apparent that modifications and variations are possible without departing from the scope of the invention defined in the appended claims.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above constructions and methods without departing from the scope of the invention, it is intended that all matter contained in the above description and shown in the accompanying drawing[s] shall be interpreted as illustrative and not in a limiting sense.

1-9. (canceled)

10. A heat control for use with an oven having at least one heating compartment including a heat source for holding pre-cooked food at a selected temperature, the heat control including
an operator interface configured for displaying information associated with the heating compartment and receiving input from an operator for controlling operation of the heating compartment,
a heat control processor for controlling operation of the heat source to deliver heat to the pre-cooked food in the heating compartment,
heat control processor executable instructions for controlling the operation of the heat source according to a programmed holding cycle heating recipe to deliver heat to the pre-cooked food in the holding compartment for a holding cycle,
heat control processor executable instructions for overriding the programmed holding cycle heating recipe with a programmed boost heating recipe for delivering a boost of heat to the pre-cooked food in the heating compartment,
the operator interface including a boost actuator, and the heat control operating in response to actuation of the boost actuator to override the programmed holding cycle heating recipe to control the heat source according to the programmed boost heating recipe to deliver a boost of heat to the pre-cooked food in the heating compartment.

11. A heat control as set forth in claim 10, wherein the boost actuator is associated with multiple heating compartments of the oven for overriding the programmed holding cycle heating recipe for the heating compartments.

12. A heat control as set forth in claim 11, wherein the operator interface includes compartment displays corresponding to respective heating compartments of the oven, the heat control processor operating in response to actuation of the boost actuator and actuation of a compartment display to override the programmed holding cycle heating recipe for the heating compartment corresponding to the actuated compartment display.

13. A heat control as set forth in claim 11, wherein the operator interface includes start actuators corresponding to respective heating compartments of the oven, the heat control processor operating in response to actuation of the boost actuator and actuation of a start actuator to override the programmed holding cycle heating recipe for the heating compartment corresponding to the actuated start actuator.

14. A heat control as set forth in claim 10, wherein the programmed boost heating recipe includes a programmed boost temperature.

15. A heat control as set forth in claim 10, wherein the programmed boost heating recipe includes a programmed time duration.

16. A heat control as set forth in claim 10, wherein the programmed boost heating recipe is time-based.

17. A heat control as set forth in claim 10, wherein the programmed boost heating recipe is temperature-based.

18. A heat control as set forth in claim 10, wherein the programmed boost heating recipe includes successive phases of different levels of boost heat temperature.

19. A heat control as set forth in claim 18, further comprising heat control processor executable instructions for controlling the heat source to deliver heat to the pre-cooked food at a first boost heat temperature followed by a second boost heat temperature less than the first boost heat temperature.

20. A heat control as set forth in claim 10, further comprising heat control processor executable instructions for controlling the heat source according to a plurality of different programmed boost heating recipes.

21. A heat control as set forth in claim 20, wherein the plurality of different programmed boost heating recipes are associated with different types of pre-cooked food.

22. A heat control as set forth in claim 20, wherein the operator interface includes a menu of the plurality of different programmed boost heating recipes for selection by an operator.

23. A heat control as set forth in claim 22, further comprising heat control processor executable instructions for displaying the menu of the plurality of different programmed boost heating recipes in response to actuation of the boost actuator.

24. A heat control as set forth in claim 20, further comprising heat control processor executable instructions for selecting a programmed boost heating recipe of the plurality of programmed boost heating recipes as a function of the type of pre-cooked food held in the heating compartment.

25. A heat control as set forth in claim 24, wherein the operator interface includes a compartment display associated with the at least one heating compartment for displaying the type of pre-cooked food held in the heating compartment, and further comprising heat control processor executable instructions for selecting a boost heating recipe as a function of the type of food displayed on the compartment display.

26. A heat control as set forth in claim 10, further comprising heat control processor executable instructions for controlling the heat source according to the programmed boost heating recipe to deliver a boost of heat to the pre-cooked food at the beginning of the holding cycle.

27. A heat control as set forth in claim 10, further comprising heat control processor executable instructions for controlling the heat source according to the programmed boost heating recipe to deliver a boost of heat to the pre-cooked food at or near the end of the holding cycle.

28. A heat control as set forth in claim 10, further comprising heat control processor executable instructions for controlling the heat source according to the programmed boost heating recipe to brown the pre-cooked food in the at least one heating compartment.

29. A heat control as set forth in claim 10, further comprising heat control processor executable instructions for controlling the heat source according to the programmed boost heating recipe to re-crisp the pre-cooked food in the at least one heating compartment.

30. A heat control as set forth in claim 10, further comprising heat control processor executable instructions for controlling the heat source according to the programmed boost heating recipe to melt cheese on the pre-cooked food in the at least one heating compartment.

31. A heat control as set forth in claim 10, further comprising heat control executable instructions for controlling the heat source according to a plurality of programmed holding cycle heating recipes.

32. A method of controlling heat in a heating compartment of an oven including a heat source for holding pre-cooked food at a selected temperature, the method including
controlling the heat source according to a programmed holding cycle heating recipe to deliver heat to the pre-cooked food in the holding compartment for a holding cycle,
overriding the programmed holding cycle heating recipe with a programmed boost heating recipe for controlling the heat source according to the programmed boost heating recipe to deliver a boost of heat to the pre-cooked food in the heating compartment.

33. An oven for holding pre-cooked food at selected temperatures, comprising
heating compartments for holding respective batches of food,
at least one heat source in each heating compartment for heating food in the compartment,
a heat control for controlling operation of the heat sources to deliver heat to the pre-cooked food in respective heating compartments, the heat control including instructions for controlling operation of each heat source according to a programmed holding cycle heating recipe suitable for holding the pre-cooked food in a respective heating compartment for a holding cycle, and
a boost actuator operable by an operator of the oven, the heat control operating in response to actuation of the boost actuator to override the programmed holding cycle heating recipe with a programmed boost heating recipe.
